(19) United States
(12) Patent Application Publication
(10) Pub. No.: US 2009/0107329 A1
(43) Pub. Date: Apr. 30, 2009

(54) JET HOPPER

(76) Inventor: Jeffrey Lynn Lee, Moyock, NC (US)

Correspondence Address: MOORE & VAN ALLEN PLLC, P.O. BOX 13706, Research Triangle Park, NC, 27709, US

(21) Appl. No.: 11/930,747

(22) Filed: Oct. 31, 2007

(51) Int. Cl. B01D 53/06; B01D 39/02; B01D 46/46

(52) U.S. Cl. 95/22; 55/356; 55/367; 95/107; 96/397

(57) ABSTRACT

Apparatus for use in injecting powder materials into the flue gasses flowing through a baghouse compartment in conjunction with the performance of selected operating processes on the compartment fabric filters first entrains the powdered material into a pressurized fluid column to create a gaseous powder material plume that is injected into the flue gasses, thereby providing a more uniform entrainment of the powder materials into the flue gasses.

### TECHNICAL FIELD

This invention relates generally to industrial baghouses which use fabric filter bags to remove particulate matter from the off-gasses produced by steelmaking operations, and more particularly to methods and apparatus for maintaining the operational state of such baghouses.

### BACKGROUND ART

Steel foundries clean and filter the flue gasses and entrained particulate matter (PM) produced during steel making operations before their release into the environment. These gasses and PM are collected in canopies placed over the originating sources (such as melt furnaces, ladle metallurgy furnaces, and casting equipment) and forced through positive pressure flow ducts as an effluent gas flow where it is subjected to scrubbers that clean the gasses and to filters that remove the PM before discharge. A common high efficiency method of removing the PM is by fabric filtration of the flue gasses in dust collection equipment known as a baghouse.

A baghouse operates in a manner similar to a household vacuum cleaner. It has a housing that is internally partitioned into one or more compartments, and each compartment is in turn partitioned into “dirty air” and “clean air” plenums. The clean air plenum is positioned above the dirty air plenum and has exhaust fans that create a negative pressure, or vacuum that draws the flue gasses and entrained PM (i.e. “dirty air”) from the facility's collection ducts, through the dirty air plenum, into the clean air plenum. A partition between plenums functions as a flow barrier which limits the air flow between them to openings in the partition. The openings, usually formed as tubes and the partition usually referred to as a “tube sheet”, are each covered with a fabric filter that removes the PM from the streaming gas as it passes through the opening. The cleaned gas is drawn into the clean air plenum and forced through the exhaust fans and the clean air plenum outlet dampers into the baghouse exhaust stack, where it is then discharged into the atmosphere.

The fabric filters must have a large surface area to limit the flow pressure drop across them, and to provide this within the limited space of the baghouse compartment the filters are formed as tubular shaped fabric bags. The bags can be up to 30 feet in length and up to 12 inches in diameter. They have an open end adapted for connection to a mating opening in the tube sheet. Depending on the baghouse method of operation, the bag filters may be housed in either of the two plenums. In those installations where the gas flows from the dirty air plenum into the bag filter's open end and the clean air exits through the filter wall (an “inside-to-outside” flow), the bags are suspended from their closed ends in the clean air plenum using springs or J-bolt suspensions connected to the clean plenum framework, and their open ends connected to the partition openings. Alternatively, in installations where the dirty air flows through the bag's wall and clean air exits through its open end (an “outside-to-inside” flow), the bags are suspended downward from their mounted opening at the tube sheet into the dirty air plenum.

As the filtered PM residue builds up on the filter surface, the bags must be cleaned. This is usually done one compartment at a time to allow for the continuing operation of the baghouse while cleaning is performed. The cleaning methods vary with the type of flow. With inside-to-outside flow the filtered PM collects on the inside bag filter wall surface and is removed with a “reverse air flow” cleaning method. Here the compartment's inlet and outlet dampers are first closed to relax the bags, then a reverse air damper is opened at the top of the compartment to introduce a clean air backflow from a clean air duct powered by a separate fan. The backflow enters the clean air plenum and passes through the walls of the suspended bag filters for a selected period of time (30 seconds to several minutes) forcing the PM residue off the filter wall into a discharge hopper at the bottom of the dirty air plenum.

In outside-to-inside flow installations the filtered PM cakes up on the outside wall surface of the bag filter, and a pulse-jet (or pressure jet) cleaning is used. In this method the compartment remains on line and a 60 to 100 pounds per square inch (PSI) pressured jet of air is forced into the open end of the bag. This causes a wavefront to be reflected back from the bag's closed, creating a standing wave (or shock wave) that flexes the bag, causing the caked PM to crack and fall off into the dirty air plenum discharge hopper. An alternative to either of these methods is a motorized shaker that vibrates the bags to dislodge the PM.

There is wear and tear on the filter bag fabric due both to the high flue gas temperatures (thermal erosion) and the mechanical flexing stresses of repeated cleaning. The standard industry practice is to change-out the entire baghouse filter array at scheduled intervals, since the majority reach their wear life at the same time. In doing this it is also an industry standard practice to coat the new bags with a chemically inert powder that provides a more uniform air flow through the filter as well as protect the fabric from moisture. This pre-coat powder, such as OPTI-COAT™¹, is a light density powder which is injected into the flue gases flowing into the compartment, where it becomes entrained in and flows with the flue gasses. Due to its particle size it accumulates on the upstream side filter fabric surface to provide the desired coating. ¹ OPTI-COAT™ is a trademark of MENARDI corporation, Trenton, S.C.

However, even within the standard replacement cycle, fabric failures occur due to premature wear and/or “burn through” from cinders in the flue gasses. These type failures are detected by monitoring the baghouse operation to ensure compliance with EPA emission standards. The parameters monitored include the opacity of the baghouse exhaust stack gasses, and the flow pressure through each baghouse compartment. Opacity is a qualitative measure that determines the degree of scattering produced when the discharged gases pass through the light beam of an opacity monitor installed in the exhaust stack. The amplitude and frequency of the scattering is directly proportional to the particle density of the discharged gas and may be correlated to an emissions standard. Exceeding the standard may indicate baghouse equipment failure, and requires confirmatory testing by the facility operator.

The measurement of the flow pressure in each bag filter compartment provides a quantitative indication of equipment failure. A baghouse compartment operates within a pressure drop range determined by its volumetric design flow rate. The compartment's instantaneous pressure is cyclic within that range. It increases slowly as PM residue forms on the compartment's fabric filter surfaces, and decreases sharply when the compartment is cleaned. The cycle then repeats itself. A sharp decrease in pressure drop, other than that due to cleaning, is indicative of flow leakage in the compartment, due either to filter failure, such as burn through, or loss of seal in the tube sheet, and this requires immediate repair by the facility operator.

A known method of identifying failed or broken bag filters in a compartment is to inject trace material into the flue gas stream upstream of the inlet to the baghouse compartment. The trace materials are in the form of fluorescent powders that are commercially available under the LEAK SEEKER®² brand manufactured by Midwesco® Filter Resources, Inc., Winchester, Va., and the VISOLITE®³ brand manufactured by the BHA Group, Inc., Kansas City, Mo. The manufacturers specify the amount of trace powder required per square foot of total filter surface area in the compartment. A typical concentration is one pound (45 kg) per 1000 square feet (93 square meters) of cloth. ² LEAK SEEKER is a registered federal trademark of Midwesco Filter Resources, Inc., Winchester, Va.³ VISOLITE is a registered federal trademark of the BHA Group, Inc., Kansas City, Mo.

As with the filter pre-coat powders, these trace material powders have a light particle weight that allows them to be quickly entrained into the flue gas, but with a large enough particle size to be trapped by operating filters. The powder entrained gas follows the lowest resistance path through the compartment and the powder accumulates at and around the site of any leak in the filters or the tube sheet partition. The leak accumulated powder is easily visible to the operator when illuminated with a monochromatic light, to pin point the leak location. The leak can then be repaired or the bag filter replaced.

The prior art method of injecting the pre-coat powders and the trace material powders into the flue gas stream is to have an operator manually scoop or shovel the powders into the gas stream through a duct access door located upstream of the inlet to the compartment. Depending on the compartment's total filter surface area this require several shovel loads of powder to achieve the necessary trace powder density. Notwithstanding the turbulence of the flue gases and the batch nature of introducing the powder into flow a shovelful at a time, this method is effective since both types of powder are light enough, and the flow turbulence great enough, to quickly disperse the powder into the gas stream. However, it is preferred, if possible, to inject the required quantity of powder into the gas stream in a more linear manner to ensure greater homogeneity of the gas powder mix and a more uniform dispersal of the powder through the compartment's bag filters.

### DISCLOSURE OF INVENTION

The present invention is to an improved method and apparatus for use by an operator to inject particulate materials into the flue gases flowing through a baghouse compartment in conjunction with, and to facilitate, the performance of periodic operating processes on the compartment fabric filters.

According to the method of the present invention, the powder materials to be injected into the baghouse flue gases are first entrained in an external fluid column to form a material plume which, when injected into the flue gas stream, thereby entrains the powder materials more quickly and more uniformly into the flue gases. In further accord with this method the entrainment of the trace material in the external fluid column is done at a metered rate to provide a uniform density plume, thereby providing a more measured entrainment of the material into the flue gases. In still further accord with the present method the trace material plum exhibits a laminar flow so as to be momentum dominated when injected into the flue gas flow to speed its entrainment therein. In yet still further accord with the present method, the powder materials is a fluorescent trace material for use in conjunction with the process of identifying leaks in the filter bags. In yet still further accord with the present method, the powder materials is a with the According to another aspect of the present invention, apparatus which produces the material plume includes: a container and a mixing valve, the container receiving and holding therein a selected measure of the powder materials and discharging it at a metered rate to the mixing valve, the mixing valve further receiving a fluid column flow from an external source and entraining the trace material into the pressurized air flow at the metered rate of discharge from the container to provide a uniform density trace material plume. In further accord with this aspect of the invention, the container is disposed in relation to the mixing valve in a manner to provide a gravity flow of the powder materials to the mixing valve. In still further accord with this aspect of the invention the mixing valve functions as an eductor that compresses the source external fluid column to create a vacuum within the mixing valve that draws the trace material from the container at a metered rate of flow which is in proportion to the flow of the fluid column. In yet still further accord with this second aspect of the invention, the size and weight of the apparatus is limited to that which allows it to be manually transported by an operator between baghouse compartments to be tested. In still yet further accord with this aspect of the invention the apparatus is primarily fabricated of aluminum.

These and other objects, features, and advantages of the present invention will become more apparent in light of the following detailed description of a best mode embodiment thereof, as illustrated in the accompanying Drawing.

### BRIEF DESCRIPTION OF DRAWING

FIG. 1, is a perspective illustration, not to scale, of an exemplary embodiment of Jet Hopper apparatus according to the present invention;

FIG. 2, is a perspective illustration, not to scale, of one element of the apparatus embodied in FIG. 1;

FIG. 3, is a partially cutaway perspective illustration, not to scale, of the element shown in FIG. 2;

FIG. 4, is a plan view, not to scale, of another element of the apparatus embodiment of FIG. 1;

FIG. 5, is a simplified, cutaway perspective illustration, not to scale, of a baghouse compartment in which the apparatus of FIG. 1 may be used;

FIG. 6, is a figurative illustration, not to scale, which is used to teach the present invention;

FIG. 7, is a figurative illustration of bag filters that have filter leaks which were identified in the practice of the testing method of the present invention;

FIG. 8, is a sectioned illustration of an alternative embodiment of one element of the apparatus embodiment of FIG. 1;

FIG. 9, is a perspective illustration, not to scale, of an alternative embodiment of the Jet Hopper apparatus of FIG. 1; and

FIG. 10, is a figurative illustration which illustrates in qualitative measure the comparative sizes of the FIG. 1 and FIG. 9 embodiments of the Jet Hopper apparatus.

### BEST MODE FOR CARRYING OUT THE INVENTION

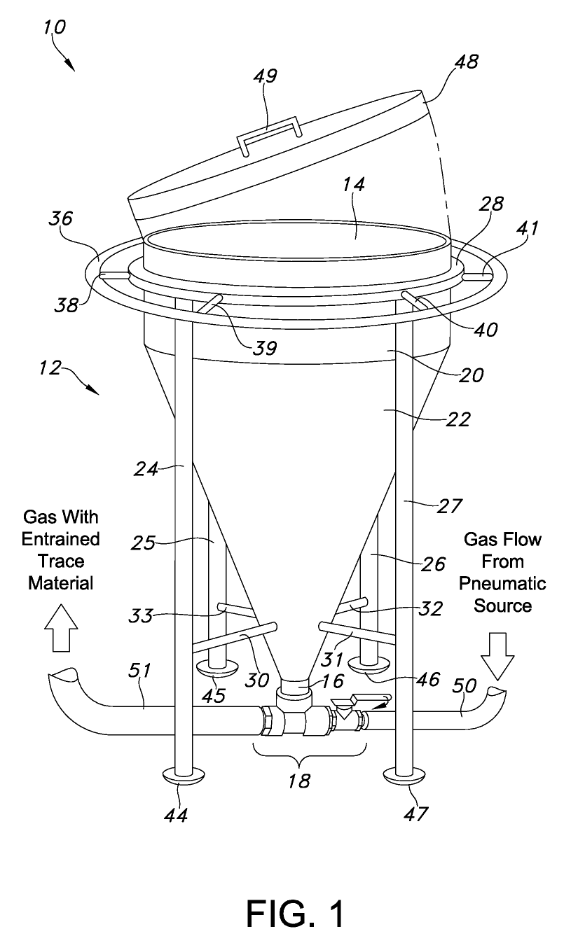

Referring now to FIG. 1, in an exemplary embodiment the Jet Hopper apparatus 10 of the present invention includes a container assembly 12 that receives the trace material through an opening 14 and releases it through a discharge nozzle 16, and a mixing valve assembly 18 that receives the material from the container and produces the trace material plume to be injected into the baghouse compartments. Subject to its specified performance requirements, the container assembly's geometry, dimensions, and holding capacity are selectable by the user.

In the FIG. 1 embodiment the chosen geometry is a circular upper portion 20 and a funnel style lower portion 22 that terminates in the discharge nozzle 16. To permit gravity feed of the trace material from the container 12 to the mixing valve 18, the container vertically positioned from ground 23 by legs 24-27 that extend downward from a mounting flange 28 on the upper portion 20. The legs 24-27 are welded to the bottom surface of the flange 28 and each are also welded at their lower extreme to one of the support brackets 30-33. The support brackets 30-33 are in turn welded at their opposite ends to the funnel portion 22 and provide lateral support to the legs.

While the principal utility of the Jet Hopper 10 is its efficiency and improved accuracy in injecting the trace material powders into the effluent gas stream, it is a tool and other important aspects of its design are in its portability and its comfort of use. The container 12 must be large enough to hold the volume of trace material necessary to perform leakage testing of a facility's largest baghouse compartment, i.e. the largest cumulative square feet of bag filter surface area, but beyond that the design stresses its portability and ease of use.

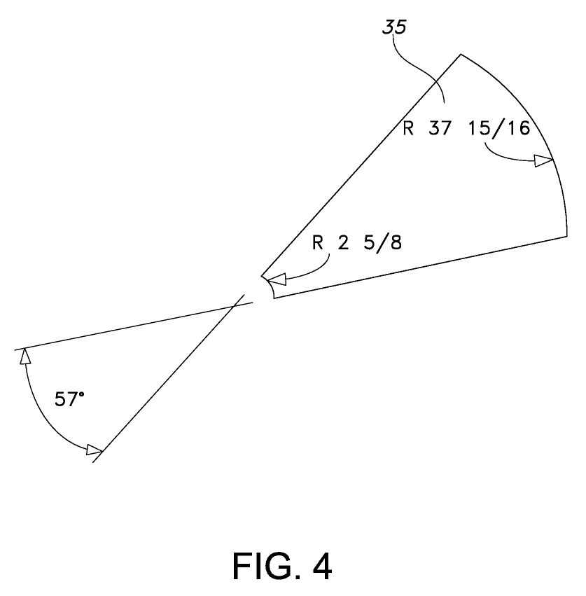

To facilitate its portability the weight of the Hopper is minimized by fabricating it from aluminum (AL). In the FIG. 1 embodiment the container assembly upper portion 20 and funnel portion 22 are made from 10GA sheet AL sections which are shaped and welded together. The funnel portion is formed from two half cone sections that are welded together, each having the flat layout geometry and radii of the pattern 35 of FIG. 4. The legs 24-27 are 1¼ inch AL pipe and the support brackets 30-33 are ¾ inch AL round bar (RB).

The mobility of the Hopper is enhanced by adding a handle 36 which functions as a grab rail that circles the upper portion 20. The handle 36 is used to pick up the Hopper or to slide it along a catwalk between baghouse compartments. The handle is welded to the flange 28 with stand-off support members 38-41 which provide space between the handle and the upper portion to allow it to be grabbed by the operator. In the FIG. 1 embodiment the handle 36 and support members 38-41 are ¾ inch AL RB. To further facilitate movement, skid plates 44-47 are welded to the bottom of the legs 24-27. to allow it to slid along a catwalk between baghouse compartments. The skid plates are ¼ inch thick, 4 inch diameter AL discs with a raised edge to minimize interference.

An AL cover 48, with handle 49 completes the assembly. The cover is used to protect the container when the unit is stored, but is not otherwise used during operation. As described, the unloaded weight of the Jet hopper is less than forty pounds. Also shown in FIG. 1 are hose connections to the mixing valve 18 which include an air inlet hose 50 that conducts pressurized air to the valve from an air source (not shown) and an outlet hose 51 that conducts the trace material plume produced by the mixing valve to the baghouse inlet duct. In this embodiment the hoses are hoses are each rated for 150 pounds per square inch (PSI).

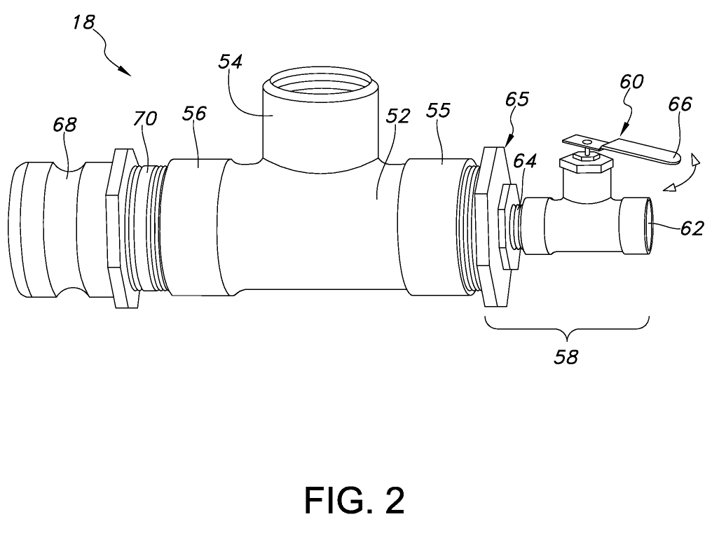

FIG. 2 is a perspective illustration, not to scale, of the mixing valve 18 which, in the FIG. 1 embodiment of the Jet Hopper comprises a galvanized cast iron Tee fitting housing 52 with three 1¼ (one and one quarter) inch inside diameter (ID) ports 54-56; each with an inside pipe thread. The port 54 functions as a material inlet through which the valve assembly 18 receives the trace material 54 from the Hopper discharge nozzle 18. In the present embodiment the discharge nozzle 18 is slidably inserted into the port 54 and the two are mechanically connected with a weld. This provides a strong mechanical mounting capable of withstanding rough handling of the Hopper, as well as hermetically sealing the interface to prevent trace material leakage. Alternatively, the discharge nozzle may be adapted for a threaded fitting to the port 54 to provide a releasable engagement.

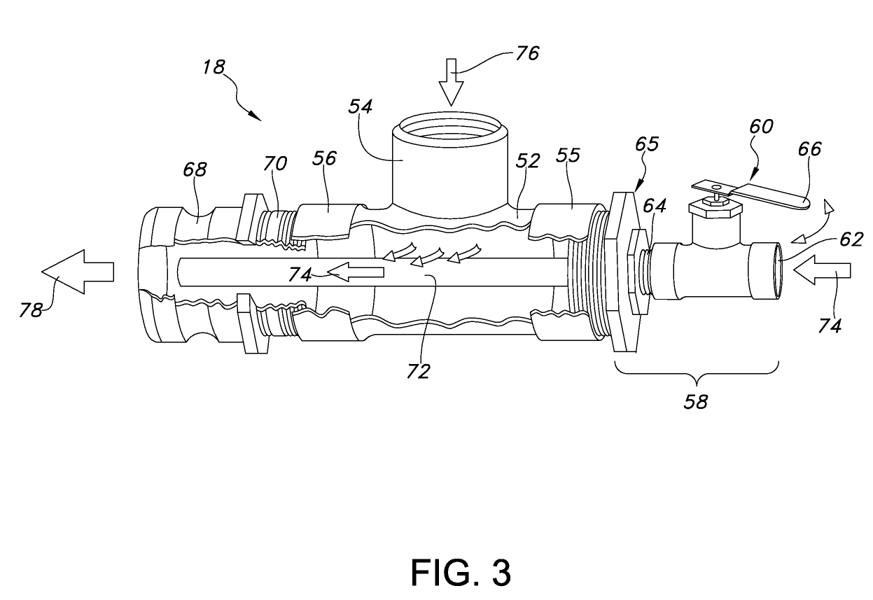

The port 55 functions as a fluid inlet to the valve assembly 18 and is adapted for connection to a fluid valve assembly 58. The fluid valve assembly 58 includes a ½ (one half) inch diameter pneumatic shut-off valve 60, with an inlet 62 that is adapted to receive a pressurized air flow from an air source (not shown) and an outlet 64 that is connected to the inlet (not shown) of a nozzle assembly 65 (shown in greater detail in FIG. 3). In this embodiment the nozzle assembly 65 is shown to be releasably mounted to the port 55 with a threaded engagement to permit removal of the assembly 58. The shut-off valve 60 includes control lever 66 which permits an operator to control the flow of air to the port 55. Port 56 is the mixing valve assembly outlet where the trace material plume is ejected, as described in detail below. The port is connected to a hose connector, or coupling 68 through threaded fitting 70.

FIG. 3 illustrates the mixing valve assembly 18 with its housing 52 peeled back to illustrate the mixing valve interior. There, a nozzle barrel 72, which is part of the nozzle assembly 66, extends from the inlet (not shown) of the nozzle assembly 65 along the length of the housing 52. The barrel 72 is a ½ (one half) inch diameter steel cylinder with its inlet being in fluid communication with the shut-off valve 60, and its outlet terminating in the hose coupling 68. In this embodiment the mixing valve functions as a an eductor, or “venturi eductor”, which is a pneumatic conveying system. In operation, with the air source connected and shut-off valve 60 open, pressurized air (white arrow 74) flows to the nozzle assembly 66 and through the nozzle barrel 72 to the mixing valve outlet port 56. The venturi effect produced as the air exits the nozzle barrel creates a vacuum at outlet port 56 which, if trace material (black arrow 76) is present at the port 54, pulls the trace material toward the outlet port 56 where it then becomes entrained into the pneumatic flow (white/black arrow 78) as it exits port 56.

In terms of eductor terminology, the port 55 is the eductor motive air inlet, the port 54 is its material inlet, and the port 56 is the eductor discharge. The eductor is a highly efficient pneumatic pump, with no moving parts, so it is rugged and ideal for the rough handling that the Jet Hopper is subject to in use. Another benefit of the eductor is that the material inlet (here port 54) is self metering. It does not require an evenly metered flow from the container 12 since as a “momentum transferring device” the eductor only entrains the amount of powder materials that the eductor itself can accelerate and convey through the outlet port 56. It is self metering. It cannot be overfed or clogged. The control variable then is the flow rate and pressure of the column of air provided to the eductor, which can be controlled by the operator either at the source of air itself, or at the fluid valve assembly 58.

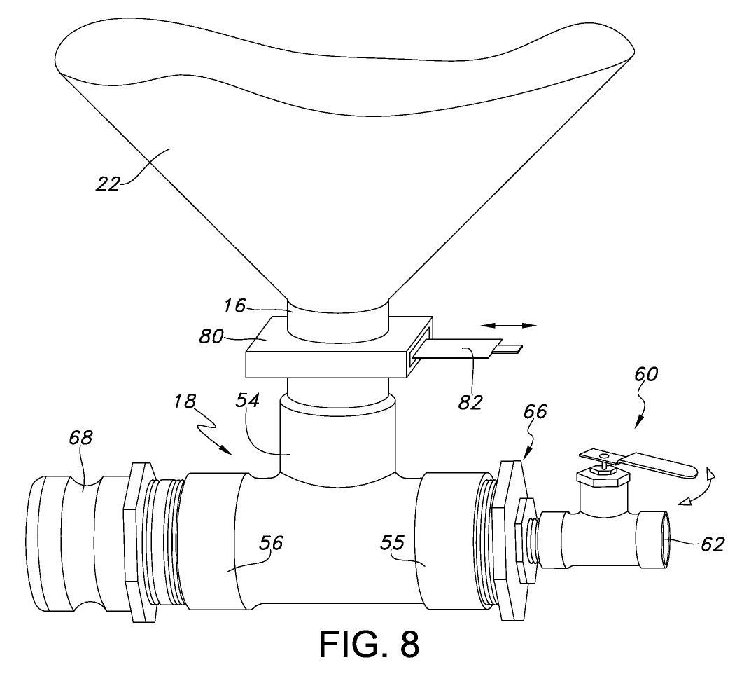

To prevent blowback of powder materials into the container assembly 12 in the FIG. 1 embodiment of the Hopper 10, the powder materials is not added to the Hopper until the shut-off valve 60 is opened, and there is a flow vacuum at the port 56 outlet. The powder materials is then immediately sucked out of the container discharge nozzle at the metered flow rate established by the vacuum created at the eductor discharge (mixing valve outlet port 56). This limitation on when the material is added to the Hopper may be eliminated by modifying the FIG. 1 apparatus by adding a gate valve 80 to the discharge nozzle 18, as shown in FIG. 8. In this example the gate valve 80 is a slide gate which is manually controlled by the operator. The gate is pushed in to close the discharge nozzle 18 and pulled out to open the discharge nozzle flow path. The normal gate position is closed. After loading powder materials into the container 12 and the source of air is applied to the eductor motive air inlet (port 55) the gate is withdrawn to open the path and the vacuum created at the eductor discharge (port 56) draws the powder materials from the discharge nozzle 16.

In the FIG. 1 embodiment the Jet Hopper is scaled in size to make it a dual use tool for injecting both the pre-coat material powder into a compartment's newly installed bag filters as well as to inject a fluorescent trace material powder to test for compartment leaks. Its size is governed by the dual considerations of the volume of powder materials it must store to complete either application and a weight that allows it to be comfortably handled and moved by an operator. The higher volume application powder materials is the pre-coat powder. It must coat the fabric filter surfaces and it is applied in a higher concentration. The manufacturer specifies 5 pounds of pre-coat powder for each 1,000 square feet of filter surface area. The trace material powder, which functions only as a dye marker for the flue gas, requires about one pound per 1,000 square feet. The pre-coat powder is also more coarse than the trace material power so it has a greater volume per unit weight. The combination of these two features means the required volume of pre-coat is almost twelve times that of the trace material volume.

In the exemplary embodiment of FIG. 1, the Jet Hopper capacity is sized to accommodate a negative pressure baghouse with exhaust fans in the clean air plenum on the downstream side of the baghouse to pull the dirty air into the baghouse and through the dirty air plenum into the bag filter's opening and out through its wall (“inside to outside”) into the clean air plenum and to the exhaust stack. There are 28 compartments, each with 216 bag filters. Each bag filter has an 11.5 inch diameter and is 360 inches in length. The Total Cloth Area (TCA) of the compartment in ft² is:

$$T C A = \frac{π \times Bag Diameter ( inches ) \times Bag Length ( inches )}{144 \frac{{( inch )}^{2}}{{( ft )}^{2}}} \times ( \# Bag Filters )$$

$$( \begin{matrix}π equals 3.14159 and is the ratio \\ of a circle ’ s circumference to its diameter\end{matrix} )$$

$$or$$

$$T C A = \frac{( 11.5 ) \times ( 3.14159 ) \times ( 360 ) {ft}^{2}}{144} \times ( 216 ) = 19 \text{,} 509.26 {ft}^{2}$$

The amount of pre-coat required for the compartment is 97.5 lbs (i.e. 5×19.5), and the required trace material is 19.5 lbs. The volume for that weight of pre-coat is slightly less than 5 cubic feet while the volume of trace material is about 0.425 ft³.

The Jet Hopper 10 is designed to hold five cubic feet of particulate material, with two cubic feet is in the upper portion 20 and three cubic feet in the funnel portion 22. The upper portion 20 is eight inches high with a 24 inch diameter and the funnel portion extends 33.5 inches from the bottom of the upper portion 20 to the top of the discharge nozzle 16, and transitions from a matching 24 inch diameter at the upper portion to 1.24 inches at the discharge nozzle. The opening 14 of the FIG. 1 Hopper 10 is forty eight inches high, which allows the operator ease of access in loading the materials.

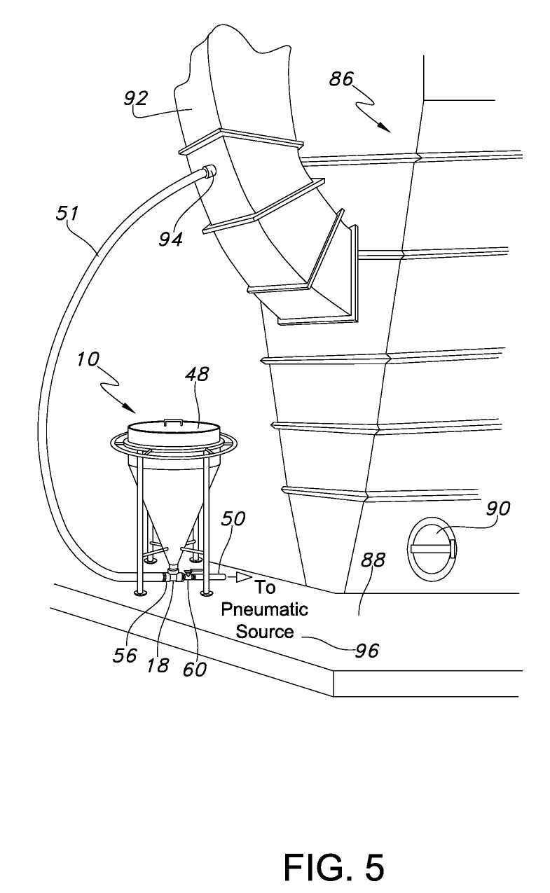

In its operation, the Hopper must be moved to the individual baghouse compartments to be treated or tested. FIG. 5 is a simplified illustration of the exterior of one compartment 86 of a baghouse installation. The compartments are typically arranged in a row column matrix, in mutually close proximity, and an interconnecting catwalk 88 give the operator access to each compartment and its access door 90. The compartment 86 receives the dirty air flue gasses on an inlet duct 92 from the facility's dust collection system. When the compartment requires leak testing or pre-coating the Jet Hopper is carried to the compartment together with the pre-coat and/or trace materials (in packaged or bulk form) and placed on the catwalk. In this description of operation we assume the task is leak testing, but the same steps are performed the pre-coat application.

The Hopper outlet hose 51 is connected to the outlet 56 of the Hopper mixing valve 18 and its delivery end is inserted into an access port 94 in the inlet duct 92. The air hose 50 is connected to a source of pressurized air 96, which is piped from a central air source to outlets along the catwalk, and the shut-off valve 60 (FIG. 1) is turned on to establish the air flow through the valve 18 and to create a vacuum at the outlet 56. The cover 48 is then removed and the required volume of trace material is added to the Hopper. The trace material powder is entrained into the pressurized air flow at the outlet 56 and travels through the hose 51 to the inlet duct 93.

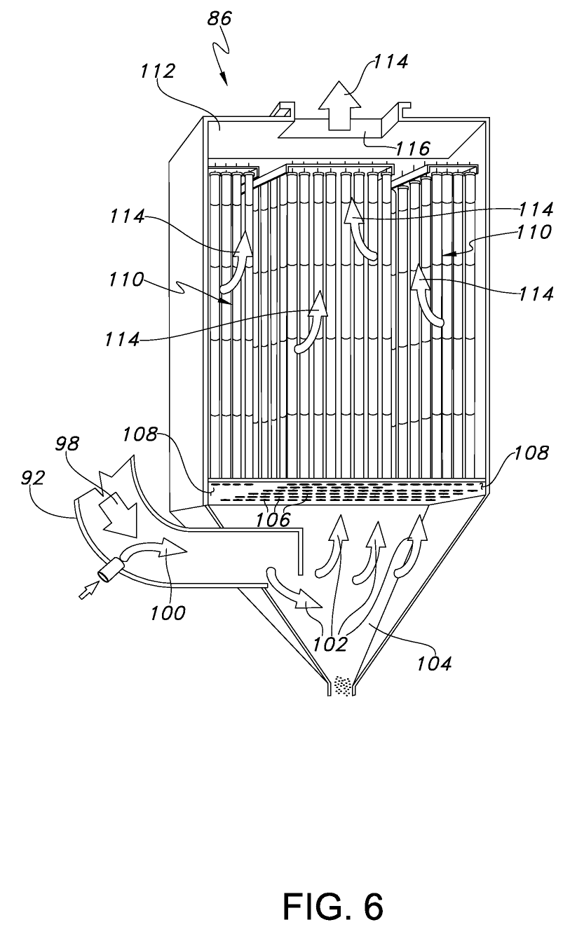

FIG. 6 is a figurative illustration of a broken away view of the interior of the compartment 86 and inlet duct 92. The dirty flue gasses 98 from the facility's dust collection system mix with the trace material plume 100 from the Hopper to provide a gas entrained trace material flow 102 that enters the compartment's dirty air plenum 104. The negative pressure created by the compartments exhaust fans (not shown) draw the gas entrained trace material into the openings 106 in tube sheet 108 and into the openings of the compartment bag filters 110, which are shown suspended in the clean air plenum 112. The gas entrained trace material flows up into the bags and through the filter walls which sieve our the trace material and a cleaned gas 114 flows into the clean air plenum and through its outlet 116 to the baghouse exhaust stack.

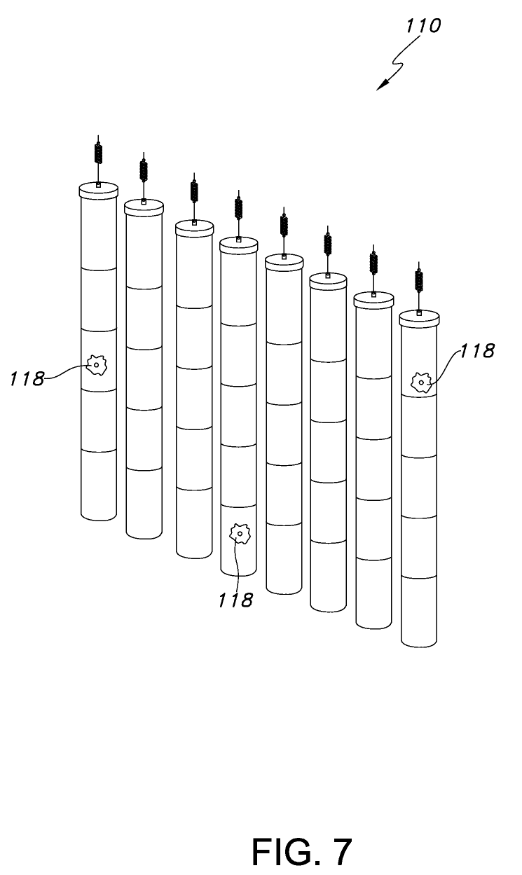

Any hole or lost seal in the bag filters 110 or tube sheet 108 provides increased permeability at the leak site and the gas entrained trace material flow accelerates as it compresses through the narrower opening of the hole. The resulting flow turbulence deposits trace material around the hole as it exits. In this “inside to outside” installation the trace material deposits are on the outside wall of the bag filter, as figuratively shown in FIG. 7 by the deposits 118 in various ones of the bag filters 110. The fluorescent trace material deposits are highly visible within the dark compartment when illuminated by an operator with an ultraviolet (UV) “Long Wave (UBV 315-280 nm) wavelength light (“black light”).

The frequency of use of the Jet Hopper for leak testing operations is much higher than that for the pre-coat operation. While change out of individual compartment bag filters may be necessary following compartment damage, such as due to a compartment fire, the full change out cycle is on the order of five years. On the other hand, the frequency of the leak testing operation may be reasonably estimated to average a once a month occurrence. The required application volume of pre-coat powder is also much greater than that of the trace powder, approximately 10 times greater. In view of this it may be desirable to provide different Jet Hoppers for each task.

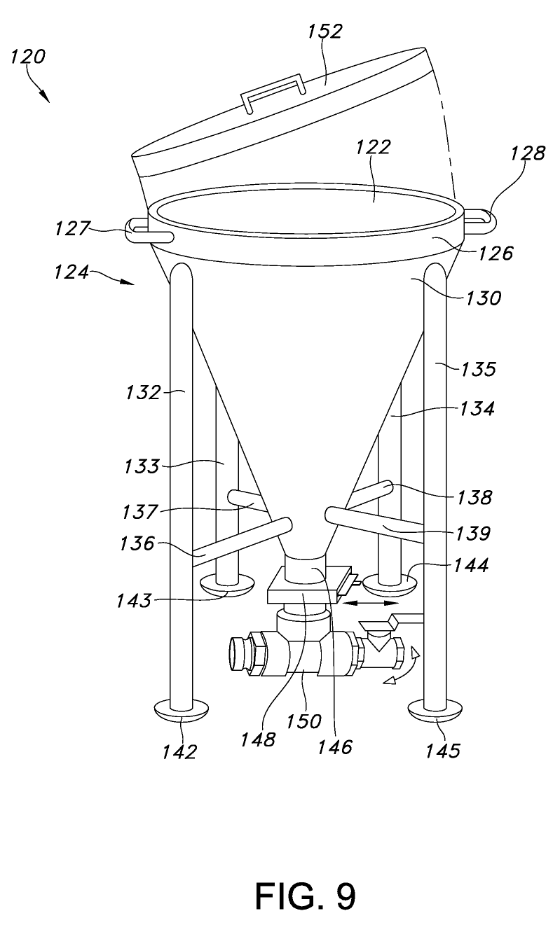

FIG. 9 is an exemplary embodiment of a Jet Hopper 120 that may be used for leak testing alone. It is identical in its functional elements and operating features to the Hopper 10 of FIG. 1, but is scaled in its overall size and volume to approximately one quarter that of the Hopper 10. The opening 122 of the container 124 is approximately twenty four inches high, half that of the Hopper 10, and the diameter of the opening 122 diameter is twelve inches, half that of the opening 14 of the Hopper 10. With the exception of a top band 126 for mounting handles 127, 128, container 124 only has the hopper portion 130, which provides an approximate 2 cubic feet of volume; about 40% that of the Hopper 10 of FIG. 1.

The Hopper 120 otherwise has the same structural elements with legs 132-135 that are welded at their top ends to the container 124 and have braces 136-139 that are welded between their lower portion and the lower extremity of the container. Skid plates 142-145 are welded to the bottom of the legs. The hopper portion 130 of container 124 has a discharge nozzle 146 with a gate valve 148. The gate valve 148 is the same as gate valve 80 of FIG. 8 and control the opening and closing of the discharge nozzle flow path to the mixing valve 150. The mixing valve 150 is the same as the valve 18 of FIGS. 1 through 3, with its eductor configuration. There is also a cover 152, and with the exception of the mixing valve 150, the Hopper 120 elements are fabricated from aluminum in similar manner and gauge as the Hopper 10.

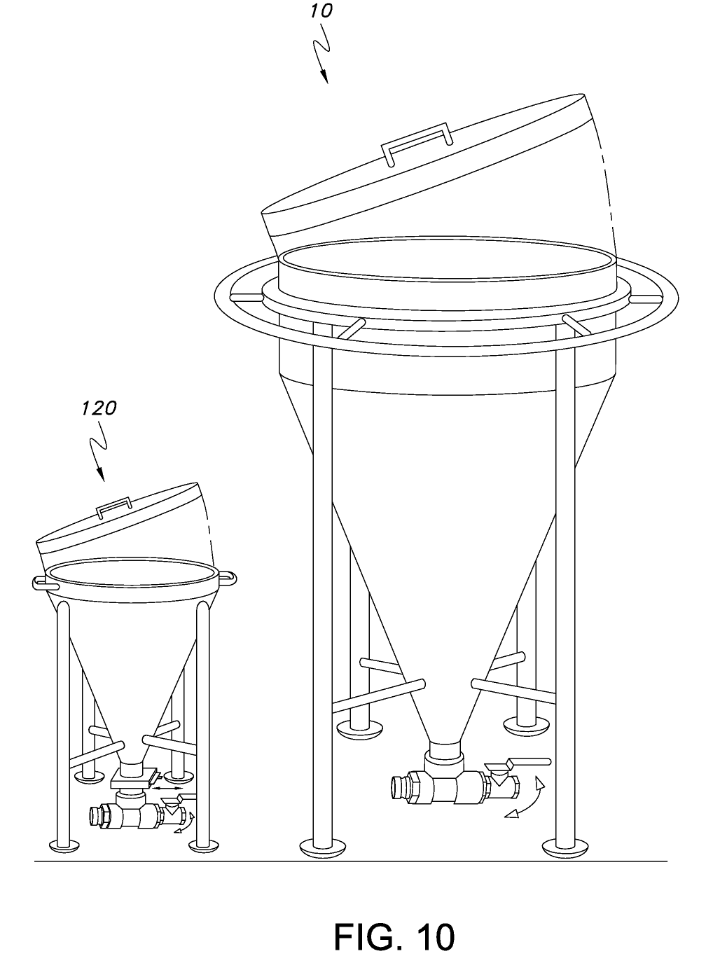

FIG. 10 is an approximate representation of the difference in the overall size between the Jet Hopper 120 of FIG. 9, which is intended for use in the leak testing operation alone, and the Jet Hopper 10 of FIG. 1 for the dual use of both pre-coat and leak testing operations. While this is only a qualitative comparison of the two configurations it does reasonably evidence the approximate one quarter size of the Hopper 120 in relation to the Hopper 10.

Although the invention has been shown and described with respect to a best mode embodiment thereof, it should be understood by those skilled in the art that various changes, omissions, and additions may be made to the form and detail of the disclosed embodiment without departing from the spirit and scope of the invention, as recited in the following claims.

I claim:

1. Apparatus, for use by an operator to inject powder materials into the flue gases flowing to a baghouse compartment in conjunction with the performance of a selected operating processes on the compartment fabric filters, the apparatus comprising:
a container, for holding a store of powder material, the container having an opening for receiving the particle matter and a discharge nozzle through which the powder material may be discharged; and
a mixing valve, for receiving the powder material from the container discharge nozzle and for receiving a flow of pressurized fluid from an external pressurized fluid source, the mixing valve entraining the powder material into the pressurized fluid flow to create a gaseous powder material plume for presentation to the baghouse compartment to inject the powder material plume into the flue gases flowing to the compartment, thereby entraining the powder material into the flue gases in performance of the selected operating process.

2. The apparatus of claim 1, wherein the container is positioned relative to the mixing valve to provide a gravity flow of the powder materials from the discharge nozzle to the material inlet of the mixing valve.

3. The apparatus of claim 2, wherein the mixing valve comprises:
a housing having a material inlet for receiving the powder material from the container discharge nozzle, an air inlet for receiving the pressurized fluid flow from the external pressurized fluid source, and an outlet for discharging the gaseous powder material plume for presentation to the baghouse compartment, the air inlet and the outlet comprising the opposite end apertures of a first bore disposed through the housing, the material inlet comprising an end aperture of a second bore that is disposed in the housing with its opposite end intersecting the first bore at a location intermediate to the air inlet and the outlet, whereby the first bore and the second bore are in fluid communication.

4. The apparatus of claim 3, further comprising:
a structural framework adapted for disposal on the container, the structural framework having a plurality of leg members to support the container in a substantially vertical position, the structural framework being further adapted to allow manual transport of the apparatus by an operator as necessary to place it in position to inject the powder material plume into the baghouse compartment on which the selected operating process is being performed;
and wherein the container and the mixing valve are each adapted for mounting the mixing valve at its material inlet to the container discharge nozzle.

5. The apparatus of claim 4, further comprising:
a fluid nozzle adapted for disposal in the mixing valve air inlet, the fluid nozzle having a mounting base adapted to mechanically engage the air inlet, the mounting base including an aperture for receiving the flow of pressurized fluid from the external pressurized fluid source, the fluid nozzle further having a barrel in the form of a cylinder having an inlet end connected in fluid communication to the mounting base aperture and having a terminal end which, with engagement of the mounting base in the air inlet, extends into the first bore to a position between the second bore intersection and the mixing valve outlet.

6. The apparatus of claim 5, wherein the mixing valve is an eductor which, in the presence of a pressurized fluid flow through the nozzle barrel, provides a venturi vacuum at the terminal end of the nozzle barrel, the venturi vacuum drawing the powdered material from the container into the material inlet at a metered rate that is dependant on the pressure and rate of flow of the pressurized fluid, to thereby provide a substantially uniform density powder material plume at the mixing valve outlet.

7. The apparatus of claim 6 wherein the pressurized fluid is presented to the mixing valve air inlet at a pressure in the range of from about 50 to about 100 pounds per square inch.

8. The apparatus of claim 6, further comprising:
a shut-off valve disposed intermediate to the fluid nozzle and the external pressurized fluid source, the shut-off valve being adapted for use by an operator to control the flow of pressurized fluid from the external pressurized fluid source to the mixing valve.

9. The apparatus of claim 6, wherein the container includes a conical shaped portion that terminates at its apex into the container discharge nozzle and that has an opening at its base to receive powder materials loaded therein by an operator; and
wherein the container and the structural framework are fabricated from aluminum.

10. The apparatus of claim 9 wherein the container is adapted to hold the full store of powder material necessary to complete the selected operating process in a single operating cycle.

11. The apparatus of claim 9 wherein the container is capable of holding the full store of a fluorescent powder material necessary to perform a complete leak test process on the baghouse compartment, as specified by the fluorescent powder material manufacturer.

12. The apparatus of claim 9 wherein the container is capable of holding the full store of a pre-coat powder material necessary to perform a complete pre-coating process on the baghouse compartment, as specified by the pre-coat powder material manufacturer.

13. The apparatus of claim 9 further comprising:
a plurality of skid plates, one associated with each leg member of the structural framework, each skid plate being mounted to the bottom of its associated leg member to facilitate the sliding of the apparatus along a surface by an operator

14. A method for injecting powder materials into the flue gasses flowing to a baghouse compartment in conjunction with the performance of selected operating processes on the compartment fabric filters, comprising:
entraining the powder materials into a pressurized fluid column to create a gaseous powder material plume; and
injecting the gaseous powder material plume into the flue gasses flowing to the baghouse compartment.

15. The method of claim 14 wherein the step of entraining comprises:
metering the flow of the powder material into the pressurized fluid column to provide a uniform density gaseous powder material plume.

16. The method of claim 15 wherein the step of entraining further comprises:
providing the gaseous powder material plume as a laminar flow so as to be momentum dominated when injected into the flue gasses, thereby increasing the speed at which the powder material is entrained into the flue gasses.

17. The method of claim 16 wherein the powder material is a fluorescent powder material for use in identifying the location of gas leaks in the compartment.

18. The method of claim 16 wherein the powder material is a pre-coat powder material for coating the surface of the compartment bag filters.

19. A method for injecting powder materials into the flue gasses flowing to a baghouse compartment in conjunction with the performance of selected operating processes on the compartment fabric filters, comprising:
using an eductor to entrain the powder materials into a pressurized fluid flow to form a gaseous powder material plume; and
injecting the gaseous powder material plume into the flue gasses flowing to the baghouse compartment.

20. The method of claim 19 wherein the step of using comprises:
providing the powder material to the material inlet of the eductor;
applying a pressurized fluid flow to the motive air inlet of the eductor; and
conveying the gaseous powder material plume formed at the eductor discharge to the baghouse compartment for injection into the flue gasses flowing therein.
